(19) United States
(12) Patent Application Publication
(10) Pub. No.: US 2006/0000454 A1
(43) Pub. Date: Jan. 5, 2006

(54) In-tank fuel supply unit having long life filter

(75) Inventors: Daven Chinubhai Bhavsar, Canton, MI (US); Heather Leigh Knechtges, Saline, MI (US); Jason Nicholas Schultz, Belleville, MI (US); Matthew Edward Wiethoff, Dexter, MI (US); Stephen T. Kempfer, Canton, MI (US)

Correspondence Address: VISTEON, C/O BRINKS HOFER GILSON & LIONE, PO BOX 10395, CHICAGO, IL, 60610, US

(73) Assignee: VISTEON GLOBAL TECHNOLOGIES, INC.

(21) Appl. No.: 10/884,534

(22) Filed: Jul. 2, 2004

(51) Int. Cl. F02M 37/04

(52) U.S. Cl. 123/509

(57) ABSTRACT

An in-tank fuel supply unit includes a fuel filter attached to a fuel delivery module for in-tank placement that does not limit the capacity of the unit or increase the size of the unit in a manner that creates undesirable packaging issues. The fuel supply unit generally comprises a fuel delivery module having a housing and a fuel pump. A fuel filter is rigidly attached to a side of the housing such that the fuel delivery module and fuel filter are placed within the fuel tank through the opening as a single unit. The fuel delivery module and fuel filter form an L-shape which permits the entire unit to be inserted through the standard opening which is sized for the fuel delivery module alone.

### FIELD OF THE INVENTION

The present invention relates generally to long life fuel filters for automotive applications, and more particularly relates to locating such a filter in the fuel tank as part of a fuel delivery module.

### BACKGROUND OF THE INVENTION

Fuel filters for automobiles are used to protect engine components and are typically installed between a fuel pump located near the fuel tank and the fuel injectors of the engine. These filters have historically been installed on the chassis fuel lines external to the fuel tank, and are designed to have a long life, preferably serviced at 30,000 to 60,000 mile increments. More recently, automobile designers have started to move this fuel filter into the fuel tank as part of a fuel delivery module. Depending on the particular manufacturer, some require that this in-tank fuel filter be serviceable.

One of the main problems with moving the fuel filter into the fuel tank is the packaging space required. An in-tank fuel supply unit typically includes a fuel delivery module (FDM) that needs to fit through a tank opening for installation as well as for removal for servicing. With varying tank heights and sizes, it can be difficult to find the packaging space necessary to incorporate a filter, while still easily fitting the filter on the FDM and into the fuel tank opening. Some solutions package the filter in a cylindrical canister which is mounted inside the reservoir of the fuel delivery module. Unfortunately, this takes up a significant portion of the reservoir capacity. Other solutions employ a filter that mounts around the fuel pump or on top of the fuel delivery module. Unfortunately, these solutions limit the tank heights that the fuel delivery module can be used with, as the assembly typically becomes much taller.

Accordingly, there exists a need to provide an in-tank fuel supply unit having a fuel delivery module and fuel filter which can easily be placed through the opening in the fuel tank during assembly or service, and which also does not limit the reservoir capacity or the size of the fuel tank on which the unit may be employed.

### BRIEF SUMMARY OF THE INVENTION

The present invention provides an in-tank fuel supply unit having a fuel filter attached to a fuel delivery module for in-tank placement that does not limit the capacity of the unit or increase the size of the unit in a manner that creates undesirable packaging issues. The fuel supply unit generally comprises a fuel delivery module having a housing and a fuel pump. A fuel filter is rigidly attached to a side of the housing such that the fuel delivery module and fuel filter are placed within the fuel tank through the opening as a single unit. The fuel delivery module and fuel filter form an L-shape which permits the entire unit to be inserted through the standard opening which is sized for the fuel delivery module alone.

According to more detailed aspects, the housing of the fuel delivery module has a greatest width Wₕ which is less than or equal to the smallest width of the opening in the fuel tank Wₒ. The fuel filter preferably has a width W_{f} less than or equal to Wₕ. The fuel filter preferably has a height H_{f} less than or equal to Wₕ. Most preferably, the square of the fuel filter height (H_{f}²) plus the square of the fuel housing width (Wₕ²) is less than or equal to the square of the smallest width of the opening (Wₒ²).

By controlling the width and height of the fuel filter, the entire in-tank fuel supply unit may be placed into and out of the fuel tank as a single unit for installation and service. At the same time, the length of the fuel filter may be sized based on the required amount of filtering capacity. The fuel filter is preferably removably attached to the fuel delivery module for selective attachment to the fuel delivery module.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a front view of an in-tank fuel supply unit constructed in accordance with the teachings of the present invention;

FIG. 2 is a perspective view of the fuel filter forming a portion of the fuel supply unit depicted in FIG. 1;

FIG. 3 is a perspective view, taken from the bottom showing the fuel filter attached to the fuel delivery module; and

FIG. 4 is a perspective view, taken from the top, of the fuel filter and fuel delivery module depicted in FIG. 3.

### DETAILED DESCRIPTION OF THE INVENTION

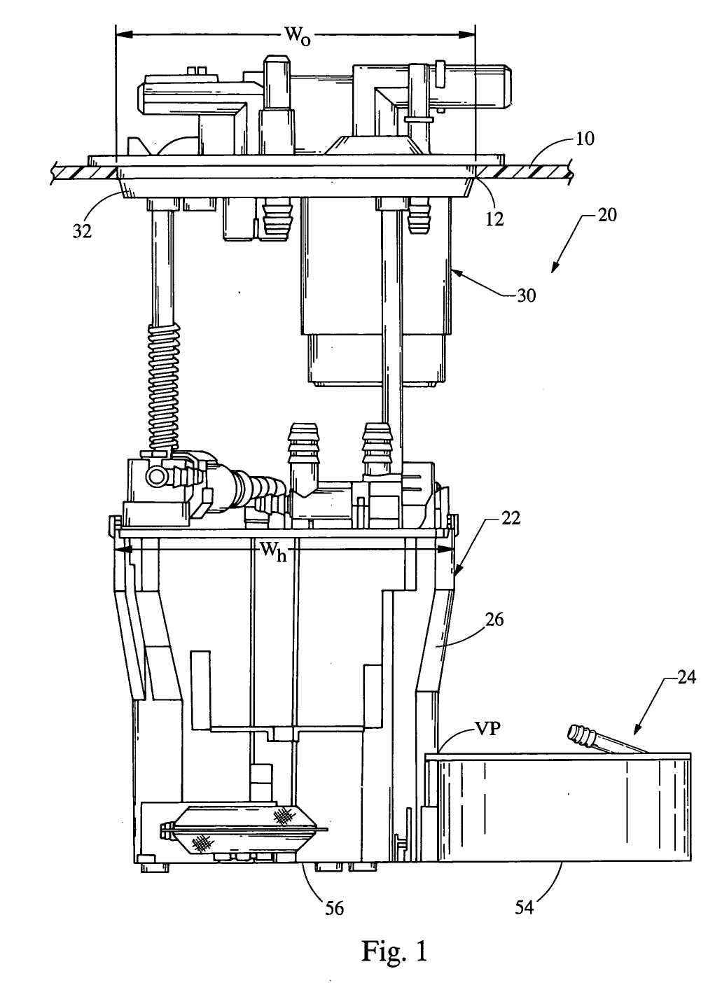

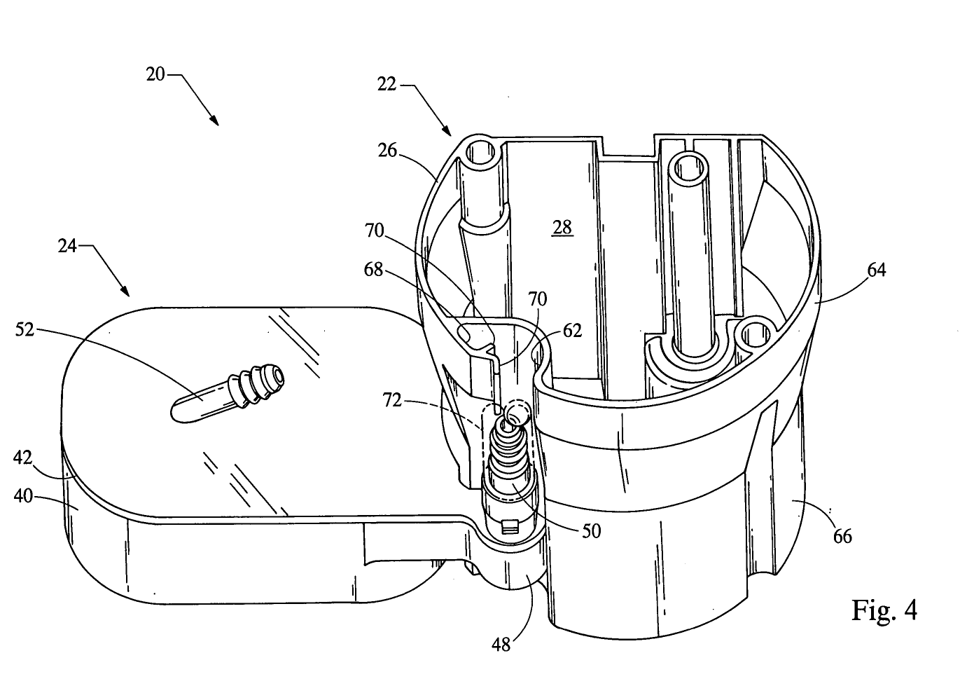

Turning now to the figures, FIG. 1 depicts a front view of an in-tank fuel supply unit 20 constructed in accordance with the teachings of the present invention. The fuel supply unit 20 generally comprises a fuel delivery module 22 having a fuel filter 24 attached thereto. The fuel delivery module 22 (FDM) generally comprises a housing 26 defining a reservoir 28 therein (FIG. 4). The fuel delivery module 22 also includes a fuel pump (not shown), although the fuel pump may be located at various positions on the FDM 22 including directly attached to the housing 26 or contained therein. It can be seen in FIG. 1 that the flange 32 is used to close off an opening 12 formed in an upper wall of the fuel tank 10, as is known in the art. The smallest width of the opening 12 has been denoted Wₒ. The greatest width of the housing 26 of the fuel delivery module 22 has been denoted Wₕ. Generally, the housing width Wₕ is less than or equal to the width of the opening Wₒ such that the fuel delivery module 22 may be easily placed directly through the opening 12 in the fuel tank 10.

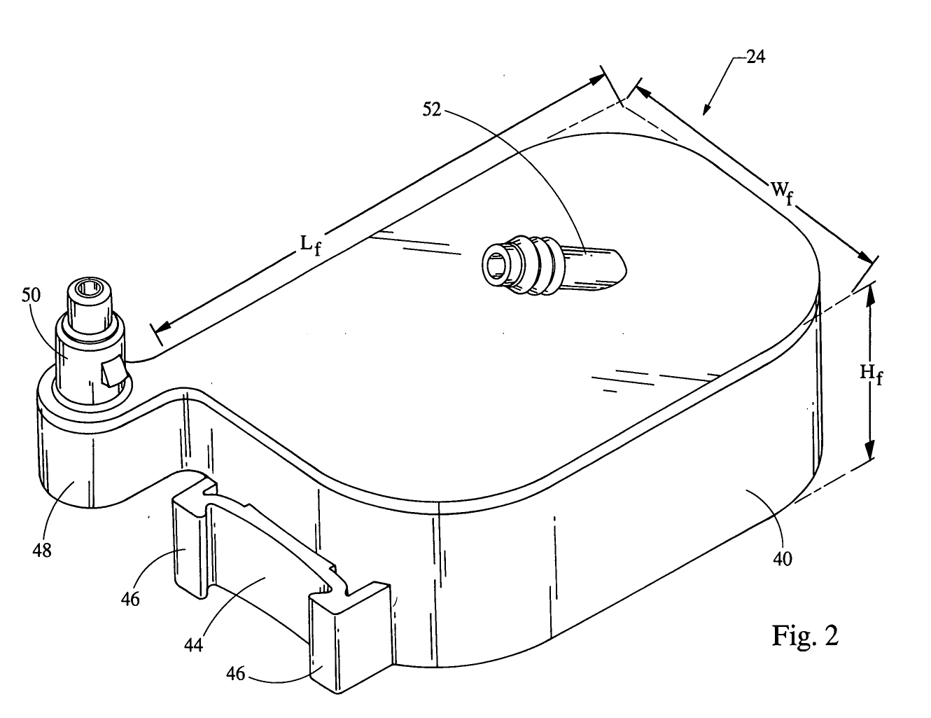

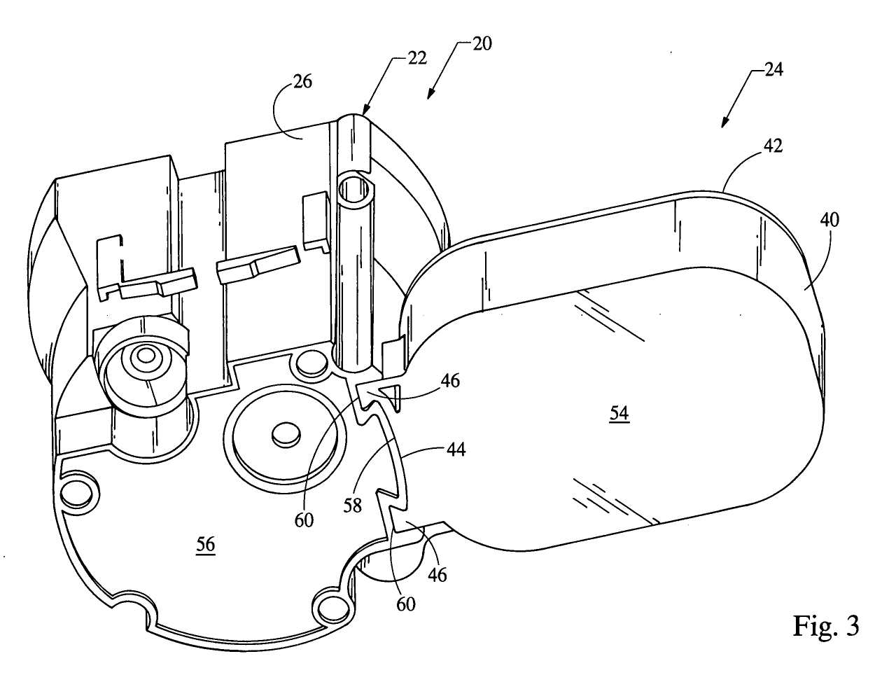

The fuel filter 24 has also been sized and structured so that it may be readily placed through the opening 12 in the fuel tank 10, even while attached directly to the fuel delivery module 22, as will be described herein with reference to FIGS. 1 and 2. As best seen in FIG. 2, the filter 24 generally includes a filter housing 40 which is enclosed by a filter cover 42. The filter 24 also includes a mounting flange 44 having two opposing projections 46, as will be described later herein and with reference to FIG. 3. The filter 24 also includes an appendage 48 which is generally cylindrical in nature and defines a filter inlet 50. Fuel flows through the inlet 50 and through filter media contained within the housing 42, and then out to the engine via a filter outlet 52. Notably, the filter outlet 52 extends upwardly and laterally towards the fuel delivery module 22, as best seen in FIG. 1.

The fuel filter 24 generally is defined by a length L_{f}, a width W_{f}, and a height H_{f}. As shown in FIG. 1, the filter 24 is attached to the fuel delivery module 22 proximate its bottom end 66 to give the fuel supply unit 20 a general L-shape which permits the entire unit 20 to be placed through the opening 12 in the fuel tank 10. In particular, the fuel filter width W_{f} and height H_{f} have been sized to permit easy placement of the unit 20 within the fuel tank 10. In particular, the fuel filter width W_{f} is less than or equal to the housing width Wₕ. Further, the fuel filter height H_{f} is less than or equal to Wₕ.

As also seen in FIG. 1, a bottom surface 54 of the fuel filter 24 is preferably aligned with a bottom surface 56 of the fuel delivery module 22. Ideally, the positioning of the fuel filter 24 and sizing of its height H_{f}, is selected such that the fuel filter 24 does not rise above a vertical position denoted VP in FIG. 1 on the housing 26 of the fuel delivery module 22. This vertical position VP is measured from a bottom surface 56 of the housing 26 and is given by the equation: \sqrt{Wₒ²−Wₕ²}. This vertical position VP and the equation for determining the same is selected to insure that the distance between the vertical position and the opposing lower corner of the housing 26 is not greater than the fuel tank opening width Wₒ.

In this way, the in-tank fuel supply unit 20 is sized and structured to provide easy placement of the fuel delivery module 22 and fuel filter 24 through the opening 12 as a single unit. During placement, the entire unit 20 is rotated such that the fuel filter 24 may be first placed through the opening 12. Then, the unit 20 is rotated and moves slightly vertically such that the fuel delivery module 22 has a vertical orientation as shown in FIG. 1. Then the entire unit 20 may be moved downwardly and the closing flange 32 secured to the fuel tank 10.

It will also be seen that the length L_{f} the fuel filter 24 need not be limited for placement of the unit 20, and thus the length L_{f} may be varied to accommodate additional filter media and to vary the filtering capacity of the filter 24.

Turning now to FIG. 3, the fuel filter 24 has been shown attached to the fuel delivery module 22. It can be seen that the housing 26 defines a recess 58 having two opposing slots 60. As previously discussed, the fuel filter 24 includes a mounting flange 44 having two opposing projections 46. As shown in FIG. 3, the recess 58 is sized to receive the flange 44, and in particular the two slots 60 are sized to receive the two opposing projections 46. Additional shapes or structures could be employed, as well as additional locking or retaining features such as snap features, as will be readily envisioned by those skilled in the art. It will thus be seen that fuel filter 24 is rigidly attached to the housing 26 of the fuel delivery module 22, while at the same time being removably attached for independent manufacture, service and assembly.

Turning now to FIG. 4, a perspective view of the fuel supply unit 20 has been shown which reveals a depression 62 formed in the housing 26 of the fuel delivery module 22. In particular, the depression 62 is semi-cylindrical in shape to correspond with the cylindrical appendage 48 projecting from the fuel filter 24. The filter 24 includes an inlet 50 located on an end of the filter 24 that abuts the housing 26 of the fuel delivery module 22. The housing 26 further defines a clip 68 having two arcuate fingers 70. A tube 72 is preferably used to connect the inlet 50 of the fuel filter 24 to an outlet of the fuel pump. Accordingly, the clip 68 is used to retain the tubing 72 within the depression 62 of the housing 26. It will readily be seen that by connecting the inlet 50 and tubing 72 to the housing 26 of the fuel delivery module 22, the connection components are protected and the integrity of the connection is maintained during placement of the fuel supply unit 20 within the fuel tank 10. Preferably, the depression 62 extends vertically from an upper end 64 to a lower end 66 of the housing 26. The depression extends vertically.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An in-tank fuel supply unit for providing fuel to an engine from a fuel tank, the fuel supply unit being placed within the fuel tank through an opening in the fuel tank, the fuel supply unit comprising:
a fuel delivery module having a housing, the housing having a greatest width Wₕ less than or equal to the smallest width of the opening Wₒ;
a fuel filter rigidly attached to a side of the housing such that the fuel delivery module and fuel filter are placed within the fuel tank through the opening as a single unit; and
the fuel filter having a width W_{f} less than or equal to Wₕ, the fuel filter having a height H_{f} less than or equal to Wₕ.

2. The fuel supply unit of claim 1, wherein the square of the fuel filter height (H_{f}²) plus the square of the fuel housing width (Wₕ²) is less than or equal to the square of the smallest width of the opening (Wₒ²).

3. The fuel supply unit of claim 1, wherein an upper surface of the fuel filter is positioned at or below a vertical position on the side of the housing, the vertical position measured from a bottom surface of the housing and given by the equation \sqrt{Wₒ²−Wₕ²}.

4. The fuel supply unit of claim 1, wherein the fuel filter has a length L_{f} greater than Wₕ.

5. The fuel supply unit of claim 1, wherein the length of the fuel filter Lf is sized based on the required amount of filtering capacity.

6. The fuel supply unit of claim 1, wherein the fuel filter projects laterally from the side of the housing to define an L-shape.

7. The fuel supply unit of claim 1, wherein the fuel filter is vertically positioned adjacent the bottom of the housing.

8. The fuel supply unit of claim 7, wherein a lower surface of the fuel filter is vertically aligned with the bottom surface of the housing.

9. The fuel supply unit of claim 1, wherein the fuel filter is removably attached to the fuel delivery module.

10. The fuel supply unit of claim 9, wherein the housing defines a recess sized to receive a flange formed on the fuel filter.

11. The fuel supply unit of claim 1, wherein the fuel filter includes an appendage projecting laterally from a body of the fuel filter, the appendage defining an inlet of the fuel filter.

12. The fuel supply unit of claim 11, wherein the housing includes a depression sized to receive the appendage of the fuel filter.

13. The fuel supply unit of claim 12, the fuel delivery module including a fuel pump, wherein the inlet is connected to the fuel pump via a hose, and wherein the depression is sized and positioned to receive the hose.

14. The fuel supply unit of claim 13, wherein the depression extends vertically.

15. The fuel supply unit of claim 13, wherein the housing further defines a clip positioned proximate the depression to engage the hose.

16. The fuel supply unit of claim 13, wherein the filter includes an inlet located on an end of the filter that abuts the housing of the fuel delivery module.

17. The fuel supply unit of claim 1, wherein the fuel filter includes a housing and a cover enclosing the housing, and wherein the cover defines an outlet of the fuel filter.

18. The fuel supply unit of claim 17, wherein the outlet extends upwardly and laterally towards the housing of the fuel delivery module.
